(19) United States
(12) Patent Application Publication
(10) Pub. No.: US 2014/0163739 A1
(43) Pub. Date: Jun. 12, 2014

(54) DYNAMICALLY-CONFIGURABLE LOCAL OPERATOR INTERFACE FOR UPSTREAM OIL AND GAS WELLHEAD CONTROL AND MONITORING

(71) Applicant: Flow Data, Inc., Grand Junction, CO (US)

(72) Inventors: Keith Thomson, Grand Junction, CO (US); Paul Brennan, Grand Junction, CO (US)

(73) Assignee: Flow Data, Inc., Grand Junction, CO (US)

(21) Appl. No.: 14/096,922

(22) Filed: Dec. 4, 2013

Related U.S. Application Data
(60) Provisional application No. 61/734,786, filed on Dec. 7, 2012.

(51) Int. Cl. G05B 15/02

(52) U.S. Cl. CPC G05B 15/02
USPC 700/275

(57) ABSTRACT

A local operator interface provides a graphical user interface to a programmable process controller (PPC) for oil and gas wellhead equipment. Configuration data reflecting the configuration of the wellhead equipment is stored by the PPC and used in controlling the operation of the wellhead equipment. A local operator interface unit retrieves the configuration data from the PPC and generates a graphical user interface on its display based on the configuration data. The operator can then selectively control operation and interact with the PPC and wellhead equipment via the graphical user interface. The local operator interface unit can be an Android-based system that also includes database management software to provide data storage and reporting capabilities.

### RELATED APPLICATIONS

This application is a continuation-in-part of Applicants' co-pending U.S. patent application Ser. No. 13/038,368, entitle “Configuration Based Programmable Logic Controller (PLC) Programming,” filed on Mar. 1, 2011, and also claims the benefit of priority to U.S. Provisional Patent Application No. 61/734,786, filed on Dec. 7, 2012, both of which are hereby incorporated by reference in their entireties for all purposes.

### BACKGROUND OF THE INVENTION

1. Field of the Invention

The present invention generally relate to the fields of process management, industrial automation, production facilities and/or process control environments. In particular, various embodiments relate to a Local Operator Interface (LOI) for oil or gas well controllers that provide, among other features, the ability to dynamically-configure interface screens based on a controller configuration file, a wireless access point, a web server and database management software (e.g., SQL) that supports historical trending of wellhead production information and parameters, local query processing and local customized report generation, for example.

2. Statement of the Problem

Oil well and gas well controllers typically include a programmable process controller (PPC) manufactured and sold by one vendor and a text-based Local Operator Interface (LOI) manufactured and sold by another vendor, both of which require programming to customize them for the particular operating environment (e.g., the number and type of measurement and control devices, such as wells, tanks, valves, etc.).

The LOI typically provides a very basic operator interface to the PPC, and has numerous shortcomings and limitations. For example, output to the operator is typically provided by a scrolling one or two-line alphanumeric-based display. Current LOIs typically include a number of function keys (e.g., a small keypad) that are used by an operator to access, input or modify values of pre-assigned registers within the PPC that store data received from measurement and control devices associated with the PPC. As such, when new measurement and control devices are added, both the PPC and the LOI require reprogramming. For example, a laptop computer may need to be connected to the LOI via a serial port to allow a configuration utility/application running on the laptop computer to facilitate assignment/mapping of the function keys to registers within the PPC that are operable to receive readings or values provided by the newly-added measurement and control device.

### Solution to the Problem

The present invention addresses these shortcomings in the prior art by providing a LOI with a graphical user interface that is dynamically configured to reflect the configuration of wellhead equipment stored in a configuration data file at the PPC.

### SUMMARY OF THE INVENTION

This invention provides local operator interface (LOI) that dynamically configures a graphical user interface to a programmable process controller (PPC) for oil and gas wellhead equipment. Configuration data reflecting the configuration of the wellhead equipment is stored by the PPC and used in controlling the operation of the PPC and wellhead equipment. A local operator interface unit retrieves the configuration data from the PPC and generates a graphical user interface on its display based on the configuration data. The operator can then selectively control operation and interact with the PPC via the graphical user interface. The local operator interface unit can be an Android-based system that also includes database management software to provide data storage and reporting capabilities.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a block diagram conceptually illustrating a simplified process control architecture in which embodiments of the present invention may be employed.

FIG. 2 illustrates exemplary configuration devices and PLC software/firmware layers in accordance with an embodiment of the present invention.

FIG. 3 is a block diagram conceptually illustrating interaction among various functional units of a dynamically reconfigurable process control application in accordance with an embodiment of the present invention.

FIG. 4 illustrates a sample of a RootConfig module definition in accordance with an embodiment of the present invention.

FIG. 5 illustrates a sample of an AnalogInputModule definition in accordance with an embodiment of the present invention.

FIG. 6 illustrates a sample of a portion of an external Modbus configuration based on the module definitions of FIGS. 4 and 5 in accordance with an embodiment of the present invention.

FIG. 7 is a flow diagram illustrating programmable process controller configuration processing in accordance with an embodiment of the present invention.

FIG. 8 is a flow diagram illustrating process control application startup processing in accordance with an embodiment of the present invention.

FIG. 9 is an example of a representation of configuration tree in accordance with an embodiment of the present invention.

FIG. 10 is a screen shot of a configuration file editing application in accordance with an embodiment of the present invention.

FIG. 11 is an example of a computer system with which embodiments of the present invention may be utilized.

FIG. 12 is a block diagram of an embodiment of the present invention using a local operator interface (LOI) 1250 to provide a graphical user interface based on the configuration file 1225 stored by the programmable process controller (PPC) 1220.

FIG. 13 is an example of configuration data retrieved by the LOI 1250 from a PPC 1220.

FIG. 14 is a simplified flowchart of the application run by the LOI 1250.

FIG. 15 is an example of an icon-based graphical user interface rendered by the LOI 1250.

FIG. 16 is an example of the graphical user interface showing two wells identified as “Baker” and “Walker.”

FIG. 17 is an example of the graphical user interface for the “Walker” well.

FIG. 18 is an example of the graphical user interface showing two storage tanks identified as “Baker” and “Walker.”

FIG. 19 is an example of the graphical user interface for the “Baker” storage tank.

FIG. 20 is a block diagram of an embodiment of the present invention using a LOI 1550 equipped with a SQL database 1552.

FIG. 21 is a diagram illustrating how report data can be selected from the SQL database using a report configuration tool.

FIG. 22 is an example of a customized graphic report that can be generated using the SQL database.

FIG. 23 is an example of a customized tabular report that can be generated using the SQL database.

FIG. 24 is an example of a screen for clipboard tag selection.

FIG. 25 is an example of a clipboard configuration.

### DETAILED DESCRIPTION OF THE INVENTION

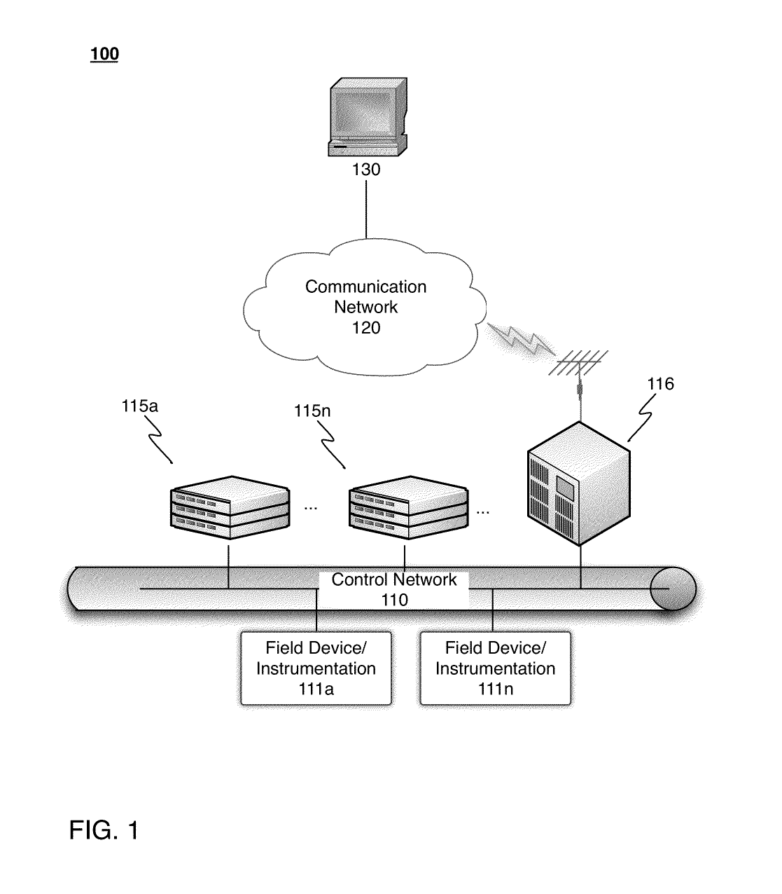

Configuration-Based PLC Programming. FIGS. 1-11 show a system and method for dynamic reconfiguration of a PLC-based process control application. According to one embodiment, a PLC is programmed by providing an process control application that is a collection of modules, each of which performs a task/operation or collections of tasks/operations, which will behave according to an externally read configuration. On boot-up, the application creates a dynamic structure of the number and configuration of each module that exists in the external configuration. The result is a dynamic method of providing a program for a PLC without having to edit the actual PLC programming code.

According to embodiments of the present invention, a process control application may be represented as a collection of modules, each having a corresponding module definition, which provides a layout and interface to adjust any internal settings applicable to that module. The definition may also provide a mapping for any output or data item that the module presents during operation.

In one embodiment, during startup of the process control application, instances of the modules list are instantiated as per the configuration that is read. This provides for a system that is object-oriented. The code for one module can be used many times (instances) with alternate configurations within a given PLC.

Also, PLCs running the same application can be given different personalities in effect as each can be configured to operate as desired by providing different configuration files. Standard protocol communications modules (e.g., Modbus RTU or Modbus TCP) and event driven communication methods provide a method for more than one PLC to be used to perform a group of associated or un-associated tasks with the same application (similar or different configurations). In one embodiment, a process control application provides a structured module tree with parent and child relationships. According to various embodiments, output from each module of the process control application is presented in standard communication protocol (e.g., Modbus RTU or Modbus TCP) to facilitate open external interface support (local operator interface, remote automation server human machine interface).

FIG. 1 is a block diagram conceptually illustrating a simplified process control architecture 100 in which embodiments of the present invention may be employed. Since embodiments of the present invention are not limited to any particular process control environment, for sake of brevity, the simplified process control architecture 100 is described at a high level. In the present example, multiple programmable process controllers (e.g., PLC 115a, PCL 115n and RTU 116) are coupled in communication with field devices/instrumentation 111a-111n (e.g., motors, solenoids, drivers, sensors, actuators, multi variable transmitters and the like—depending upon the context) via a control network 110 (e.g., typically using an electrical signal or ubiquitous physical network, such as Ethernet, and a network communication protocol standard, such as Modbus Plus, Modbus TCP/IP, Modbus RTU, BACnet, DeviceNet, LONWorks and the like) to allow input signals to be received from and commands to be provided to field devices/instrumentation 111a-111n.

Depending upon the memory, I/O and processing requirements of the industrial automation or process control environment at issue, the PLCs 115a-115n might be small, non-modular PLCs (also known as fixed I/O PLCs), such as the MELSEC FX3U compact (available from Mitsubishi Electric), which generally accommodate a smaller number of inputs and outputs in fixed configurations; or a modular/rack type PLC having a chassis or bases/racks that allow installation of multiple I/O modules, and which typically accommodate more complex applications. Two non-limiting examples of such modular type PLCs include the Modicon Quantum rack/backplane system (available from Schneider Electric), which can be configured with the desired number of Modicon Quantum Unity stand-alone processor modules, discrete input modules, analog input modules and hot standby modules; and the PLC-5/1771 system (available from Rockwell Automation, Inc.), which can also be configured with the desired number of PLC-5 processor modules, 1771 communication modules, 1771 I/O modules and a 1771 power supply in a 1771 chassis platform. As is typical, in the present example, raw or processed data may be communicated to a local or remote supervisory system through a communication network 120 (e.g., the Internet).

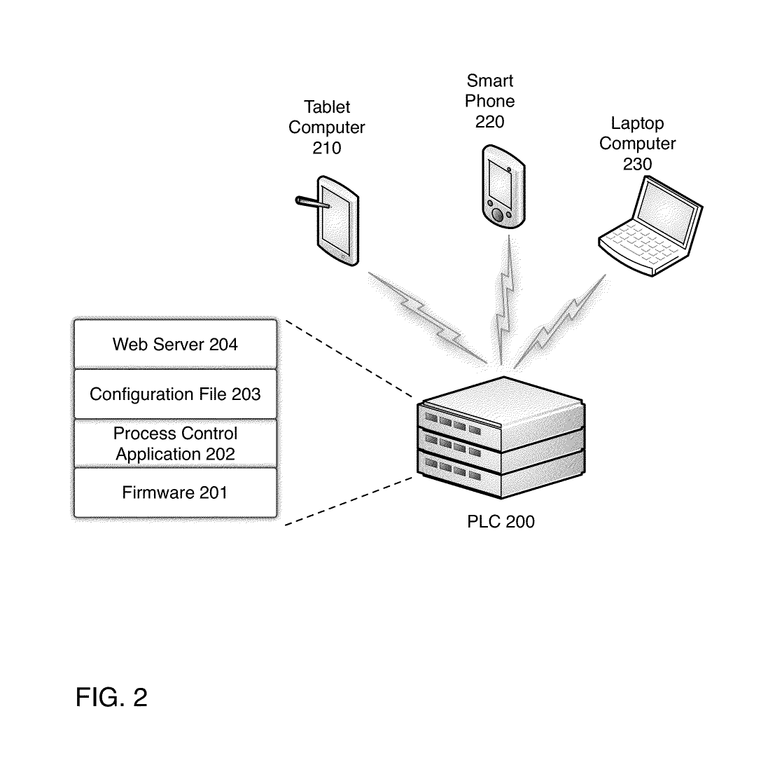

FIG. 2 illustrates exemplary configuration devices 210, 220 and 230 and software/firmware layers 201-204 of a PLC 200 in accordance with an embodiment of the present invention. In the present example, the configuration of PLC 200 can be changed by means of direct physical (e.g., RS-232 or the like) or wireless communication (e.g., Bluetooth or the like) with a mobile wireless device, including, without limitation, a tablet computer 210 (e.g., an iPad, Xoom or the like), a smart phone 220 (e.g., an iPhone, BlackBerry and Android-based phone) or a laptop computer 230.

In the present example, PLC 200 includes firmware 201, a process control application 202, a configuration file 203 (external to the process control application 202) or an optional web server 204. Firmware 201 represents, for example, PLC manufacturer code stored in read-only memory of PLC 200 to support various types of smart devices and I/O functionality.

According to embodiments of the present invention, process control application 202 is a compiled modular, object-oriented program written in a high-level programming language (e.g., the C or C++ programming language). As described in further detail below, in one embodiment, process control application 202 is a collection of modules (e.g., a superset of that which might be needed by any particular PLC), each with a module definition, which provides a layout and interface to adjust any internal settings applicable to that module. The module definition may also provide a mapping for any output or data item that the module presents during operation.

As described further below, in various embodiments of the present invention, during startup, process control application 202 is programmed to locate and read configuration file 203 to determine its structure and memory allocation usage. Configuration file 203 may contain information regarding a desired number of instances and desired configurations of modules defined by process control application 202. In this manner, the structure and memory allocation usage of process control application 202 can be dynamically reconfigured at startup by simply editing various parameters of configuration file 203 or replacing configuration file 203 with a new configuration file.

In one embodiment, the web server 204 is integrated within the PLC 200. Web server 204 enables, for example, physically connected or wirelessly connected configuration devices to access pre-programmed web pages designed to display and allow editing of parameters of configuration file 203 using standard Internet/Web protocols.

According to embodiments of the present invention, configuration devices 210, 220 or 230 may make a Bluetooth connection with the PLC 200 and thereafter use a browser-based interface provided by the web server 204 to read a current configuration data file (e.g., configuration file 203) from PLC 200, write a new or edited configuration file to PLC 200, read a current process control application (e.g., process control application 202) from PLC 200, write a new or edited process control application to PLC 200 or otherwise read from or write to data/status registers or memory of PLC 200.

Notably, while reconfiguration of PLC 200 can be accomplished by providing PLC 200 with a new or revised process control application, in embodiments of the present invention, the structure (e.g., type of module instances), memory allocation (e.g., number of module instances) and intended function of process control application 202 can be dynamically reconfigured without editing and recompiling process control application 202 by simply modifying configuration file 203, which is read at startup by process control application to configure itself as described further below. Advantageously, in this manner, it is not necessary to send skilled PLC programmers into the field to reconfigure PLC 200. Rather, using embodiments of the present invention, a lesser skilled technician can enhance or otherwise change the functionality of process control application 202 by simply using a browser-based interface, for example, to edit or replace configuration file 203.

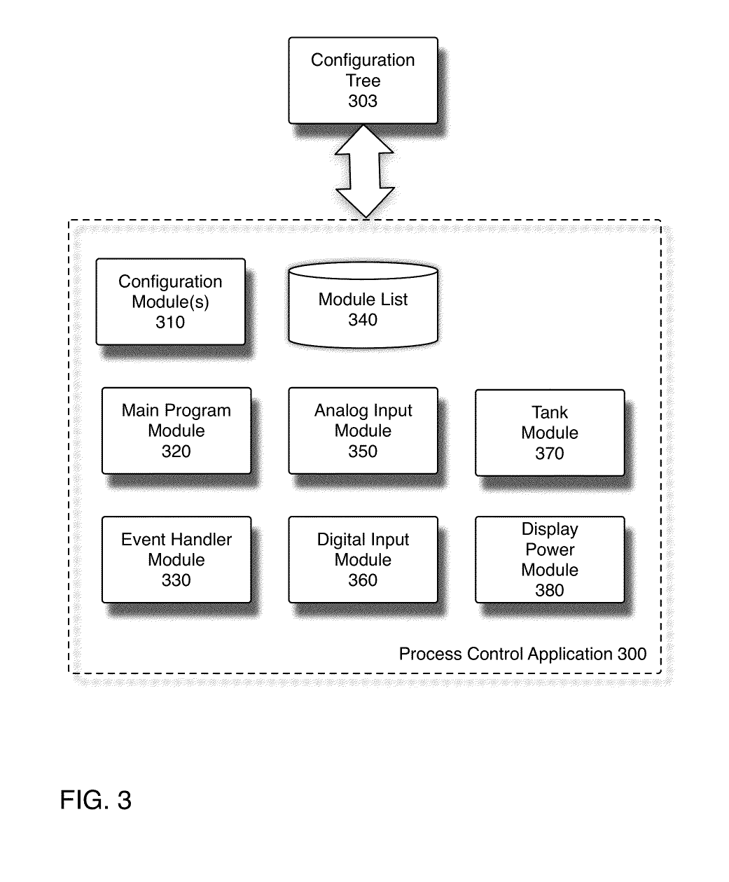

FIG. 3 is a block diagram conceptually illustrating interaction among various functional units of a dynamically reconfigurable process control application 300 in accordance with an embodiment of the present invention. According to one embodiment, process control application 300 defines a number of classes or modules that can be instantiated based on directives provided by an external configuration file (e.g., configuration tree 303) by one or more configuration modules 310.

In accordance with one embodiment, after programmable control processor (e.g., PLC 200) boots up, process control application 300 is started up, which instantiates main program module 320. Main program module 320, reads the root portion of the configuration and then instantiates an event handler module 300 (e.g., RootEvtHandler, or rather a child class of this known as a RootConfig object), which is specialized for the hardware (e.g., the type of PCL processor) process control application 300 is compiled to.

According to the present example, configuration module(s) 310 are the next layer on top of the event systems. In one embodiment, configuration module(s) 310 wrap up a platform independent or less dependent modules into a modules compatible with the hardware platform at issue through sub-classing, thereby tailoring the modules to the environment in which process control application 300 finds itself.

In accordance with one embodiment, during startup configuration processing, process control application 300 instantiates one or more configuration modules 310, e.g., a RootConfig object and a RunConfig object, which are responsible for processing configuration tree 303. According to one embodiment, configuration tree 303 represents a configuration file external to process control application 300 that has been previously written by a configuration device into a Modbus address space within the programmable process controller in which process control application 300 resides. In alternative embodiments, configuration tree 303 may be a text file or XML file stored in a memory associated with a configuration device with which the programmable process controller is in communication or a removable, portable memory stick (e.g., a USB flash drive or the like) physically interfaced with the programmable process controller. Alternatively, configuration tree 303 may be a text file or XML file that has been previously stored, by a configuration device or a removable, portable memory stick, within a memory of a programmable process controller in which the process control application resides.

In one embodiment, the instantiated configuration module 310 reads configuration tree 303 to determine if the specified configuration is valid. A status flag (not shown), which can be monitored external to process control application 300, can be utilized to provide status.

In one embodiment, RootConfig is created at the start of process control application. It inspects a set address in a memory associated with the programmable process controller (for example, Modbus address 41999) that contains a pointer to a RootConfig data structure (not shown). As described further below, according to one embodiment, the first word of this data structure is a count of active modules (e.g., a number of modules desired to be instantiated), and the following words consist of a module type identifier, followed by a relative or absolute address for the module specified. According to one embodiment, if the address is below 10000, then it is considered a relative address from the beginning of the configuration record. If it is above 40000, it is considered absolute. Process control application 300 then instantiates an object of the specified type and adds it to module list 340. If the module at issue is a Run or a Tank, a Run or Tank number of the created object is identified and a pointer to it is added to the Run or Tank lists (not shown). The run and tank lists are used for indexed events. For example, if an event has a run and tank value of 0, then it may only be sent to the RootConfig object's own modules. If it is −1, then it may be sent to all runs or all tanks as well as the RootConfig objects. If it is any other number, then it may be sent to that run, along with the RootConfig objects.

According to one embodiment, another instance of configuration module 310, RunConfig module, does roughly the same thing as RootConfig, except it first identifies its run number and stores it at the beginning of its record. RunConfig has no support for child runs. It merely dispatches all events to all of its child modules, and watches for changes in configuration.

In one embodiment, after main program module 320 and configuration modules 310 complete startup configuration processing, main program module 320 enters a main event loop in which event handler module 330 repeatedly sends time event (e.g., EVTTIME) methods to the root object of the module list 340. These time events then trigger all other events in program control application. In one embodiment, event handler objects do not have access to the system clock (not shown). According to one embodiment, in order to permit synthetic testing, the clock time (not shown) is passed in via a time event from the main event loop to the event driven code.

Other tasks or features can be added to the base process control application 300 in the form of one or more additional modules. According to one embodiment, the original collection of modules and the fact that all new modules carry a unique module identification number insures backwards compatibility. Additionally, external interfaces can be created easily as each module has a set definition stating what controls exist in the module and what data the module outputs.

As alluded to above, in one embodiment, the interaction between modules is based on an event driven system to provide for efficiency on memory and CPU usage. The event driven interaction also lends itself to efficient inter-PLC communication between multiple PLCs using the application. Communication within the structure is handled by an event driven system. According to one embodiment, events are sent via a recursive function call to the root of the structure and then are distributed in a depth first manner. Objects ignore any event that they do not need and return immediately. To avoid runaway recursion, events are only sent in response to an EVTTIME event, which is the main loop of process control program 300. Events themselves may either be statically allocated in the object that sends them or allocated on the stack by a method in that object. Events are disposed of upon return from the event call, so if another object wishes to queue an event it makes a local copy. Event objects may keep a size variable to allow for copying. Event objects also contain generic access methods to allow for extraction of the data in any format, including conversion of units and contains variables indicating the quality of the value.

In one embodiment, every other module has a configuration piece as well, and is instantiated with a pointer to its own configuration. Through this method, process control application 300 dynamically configures itself at startup with only a single hard-coded address. All modules then handle and understand their own configuration.

In various embodiments, another notable aspect of the system is support for synthetic testing. Every module includes five source files along with a makefile. There is a source and header file for the actual module itself, a source and header file for the synthetic test that verifies the operation of the module, and a final source file to be compiled when that test should be run individually. If one wishes to run all tests in the system, one merely adds the modules to the unit-test module and compiles it. Having full testing suites on every module can prevent module level regressions in functionality in an environment isolated from the rest of the program.

In the current simplified example, in addition to configuration modules 310, event handler module 330, module list 340 and main program module 320, process control application 300 includes various other modules for performing process control/monitoring tasks, including an analog input module 350, a digital input module 360, a tank module 370 and a display power module 380. While for sake of brevity only a limited set of exemplary modules are illustrated in the present example, those skilled in the art will appreciate that numerous other types of modules may be provided, including, but not limited to digital output control, PID control, Analog output control, alarming, data logging, digital cause and effect control, flow totalizer, pump control.

In one embodiment, the functionality of one or more of the above-referenced functional units may be merged in various combinations. For example, configuration module(s) 310 and event handler module 330 may be merged. Moreover, the functional units can be communicatively coupled using any suitable communication method (e.g., message passing, parameter passing, and/or signals through one or more communication paths etc.). Additionally, the functional units can be physically connected according to any suitable interconnection architecture (e.g., fully connected, hypercube, etc.).

According to embodiments of the invention, the functional units can be any suitable type of logic (e.g., digital logic) for executing the operations described herein. Any of the functional units used in conjunction with embodiments of the invention can include machine-readable media including instructions for performing operations described herein. Machine-readable media include any mechanism that provides (i.e., stores or transmits) information in a form readable by a machine (e.g., a computer). For example, a machine-readable medium includes read only memory (ROM), random access memory (RAM), magnetic disk storage media, optical storage media, flash memory devices, electrical, optical, acoustical or other forms of propagated signals (e.g., carrier waves, infrared signals, digital signals, etc.), etc.

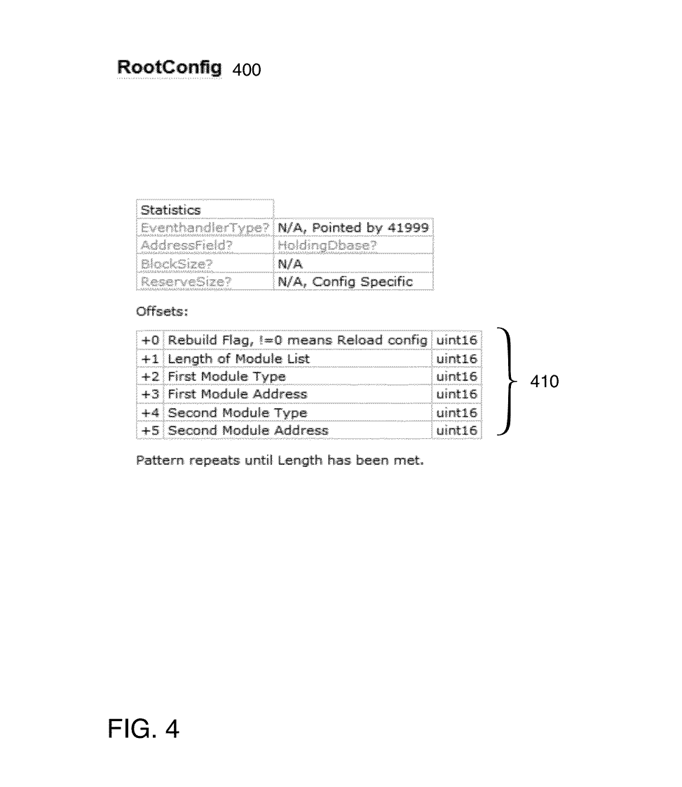

FIG. 4 illustrates a sample of a RootConfig module definition 400 in accordance with an embodiment of the present invention. As indicated above, upon startup of a process control application (e.g., process control application 202 or 300), a RootConfig object is instantiated to process an external configuration file (e.g., configuration file 203 or configuration tree 303). According to one embodiment, the external configuration file is written into a Modbus address space by a configuration device starting at an address specified at a preset address (e.g., Modbus address 41999). The first bytes of information in the external configuration file represent the RootConfig object. As such, during startup, process control application reads the hardcoded Modbus address to locate the Modbus address at which the RootConfig object is defined.

In the present example, a first data value of a set of data values 410 in the external configuration file is a rebuild flag. If this value is not equal to zero, then it is assumed that the data read from the external configuration file has been corrupted or otherwise misread and the external configuration file is reloaded into Modbus address space. If the rebuild flag is equal to zero, then processing of the configuration file data continues with the length of module list data value. This data value indicates how many module instances are to be created. The remaining data values (i.e., first module type, first module address, second module type, second module address), indicate the type of module that is to be instantiated, for example, by identifying it by number and the address offset within the configuration file at which the module configuration information (e.g., desired module parameter values) can be found. This pattern is repeated until the end of the module list is reached.

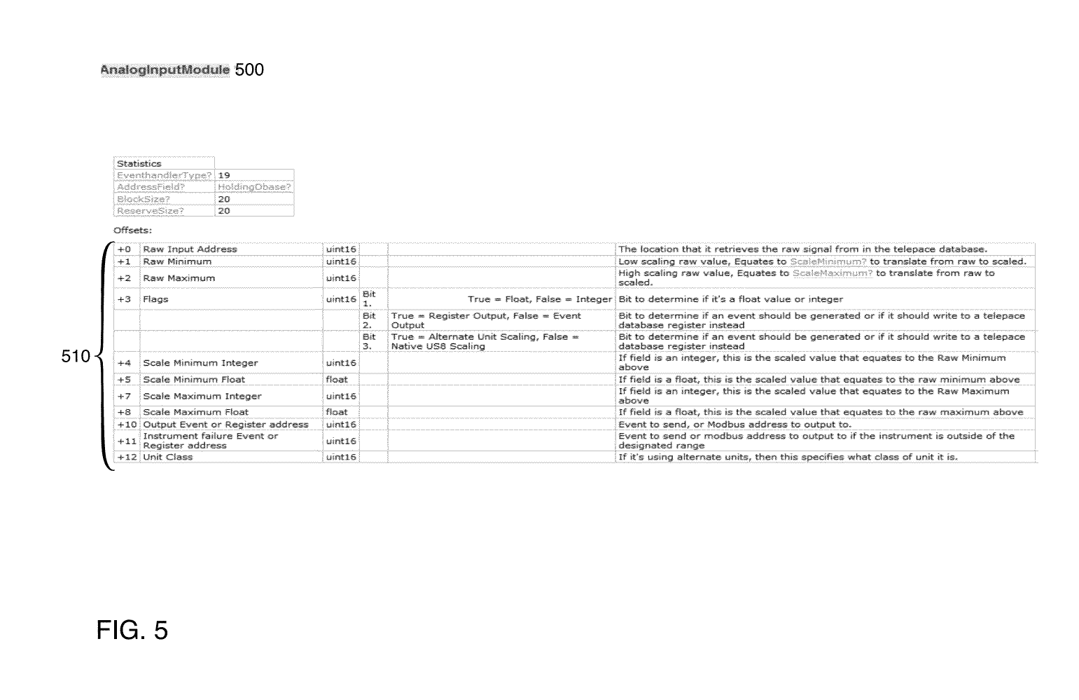

FIG. 5 illustrates a sample of an AnalogInputModule definition 500 in accordance with an embodiment of the present invention. According to the present example, data values 510 define various parameters of the desired instance of the analog input module (e.g., analog input module 350). In the present example, data values 510 include the following: a raw input address, a raw minimum, a raw maximum, a set of flags, a scale minimum integer, a scale minimum float, a scale maximum integer, a scale maximum float, an output event or register address, an instrument failure event or register address and a unit class.

In operation, during startup of process control application, these data values 510 are read from the external configuration file and understood with reference to module definition 500 and an appropriate analog input module instance configured in accordance with the data values 510 is created within process control application.

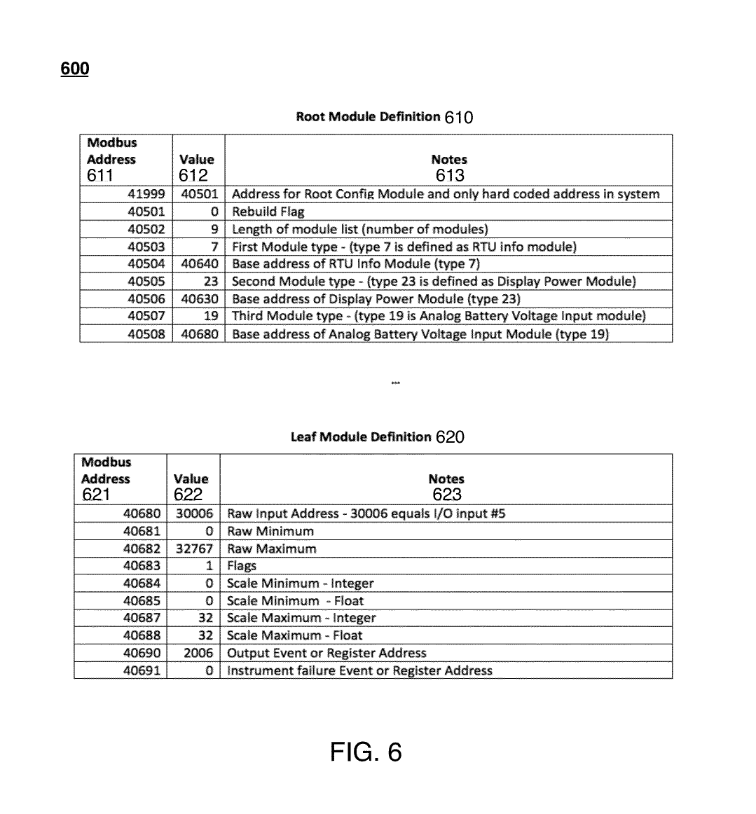

FIG. 6 illustrates a sample of a portion of an external Modbus configuration 600 based on the module definitions of FIGS. 4 and 5 in accordance with an embodiment of the present invention. According to this simplified example the external Modbus configuration 600 is represented in the form of two tables, a root module definition 610 and a leaf module definition 620, with intervening module definitions excluded for brevity. Root module definition 610 is represented in tabular form with Modbus addresses 611 in the left-hand column, values 612 stored at the corresponding Modbus addresses 611 in the middle column and notes 613 in the right-hand column. Similarly, Leaf module definition 620 is represented in tabular form with Modbus addresses 621 in the left-hand column, values 622 stored at the corresponding Modbus addresses 621 in the middle column and notes 623 in the right-hand column.

In operation, during startup of the process control application, root module definition 610 is initially located by the process control application initially retrieving the value stored at Modbus address 41999, which in the present example is 40501. The process control application, then begins reading the root portion of the configuration (i.e., root module definition 610) at Modbus address 40501.

According to the RootConfig module definition 400 (see FIG. 4), the first 16 bits of data (beginning at offset +0 from the base address of the RootConfig module definition 400 in the configuration file) are to be interpreted as a “Rebuild Flag” in the form of an unsigned integer. In the present example, the “Rebuild Flag” is 0.

According to the RootConfig module definition 400 (see FIG. 4), the next 16 bits of data (beginning at offset +1) are to be interpreted as a “Length of Module List” in the form of an unsigned integer. In the present example, the “Length of Module List” is 9—meaning the configuration file specifies 9 modules are to be instantiated by the process control application and are to be configured as further specified by the configuration file.

According to the RootConfig module definition 400 (see FIG. 4), the next 16 bits of data (beginning at offset +2) are to be interpreted as a “First Module Type” in the form of an unsigned integer. In the present example, the “First Module Type” is 7, which corresponds to an RTU info module.

According to the RootConfig module definition 400 (see FIG. 4), the next 16 bits of data (beginning at offset +3) are to be interpreted as a “First Module Address” in the form of an unsigned integer. In the present example, the “First Module Address” is 40640, which indicates data values specifying various parameters of the RTU info module begin at Modbus address 40640.

According to the RootConfig module definition 400 (see FIG. 4), the next 16 bits of data (beginning at offset +4) are to be interpreted as a “Second Module Type” in the form of an unsigned integer. In the present example, the “Second Module Type” is 23, which corresponds to a display power module.

According to the RootConfig module definition 400 (see FIG. 4), the next 16 bits of data (beginning at offset +5) are to be interpreted as a “Second Module Address” in the form of an unsigned integer. In the present example, the “Second Module Address” is 40630, which indicates data values specifying various parameters of the display power module begin at Modbus address 40630.

According to the RootConfig module definition 400 (see FIG. 4), the next 16 bits of data (beginning at offset +6) are to be interpreted as a “Third Module Type” in the form of an unsigned integer. In the present example, the “Third Module Type” is 19, which corresponds to an analog battery voltage input module.

According to the RootConfig module definition 400 (see FIG. 4), the next 16 bits of data (beginning at offset +7) are to be interpreted as a “Third Module Address” in the form of an unsigned integer. In the present example, the “Third Module Address” is 40680, which indicates data values specifying various parameters of the analog battery voltage input module begin at Modbus address 40630.

For purposes of simplicity, the forth through the eighth module definitions have been skipped in this example as indicated by the ellipsis between root module definition 610 and leaf module definition 620.

As such, the present discussion now continues with the last module definition (i.e., leaf module definition 620), representing the ninth (and last) module specified by the external configuration file.

According to the present example, the last module is an instance of an AnalogInputModule 500 (see FIG. 5). According to the AnalogInputModule definition 500 (see FIG. 5), the first 16 bits of data (beginning at offset +0 from the base address of the AnalogInputModule definition 500 in the configuration file) are to be interpreted as a “Raw Input Address” in the form of an unsigned integer. In the present example, the “Raw Input Address” is 30006.

According to the AnalogInputModule definition 500 (see FIG. 5), the next 16 bits of data (beginning at offset +1) are to be interpreted as a “Raw Minimum” in the form of an unsigned integer. In the present example, the “Raw Minimum” is 0.

According to the AnalogInputModule definition 500 (see FIG. 5), the next 16 bits of data (beginning at offset +2) are to be interpreted as a “Raw Maximum” in the form of an unsigned integer. In the present example, the “Raw Maximum” is 32767

According to the AnalogInputModule definition 500 (see FIG. 5), the next 16 bits of data (beginning at offset +3) are to be interpreted as a set of three “Flags” in the form of an unsigned integer. In the present example, the “Flags” value is 1.

According to the AnalogInputModule definition 500 (see FIG. 5), the next 16 bits of data (beginning at offset +4) are to be interpreted as a “Scale Minimum Integer” in the form of an unsigned integer. In the present example, the “Scale Minimum Integer” is 0.

According to the AnalogInputModule definition 500 (see FIG. 5), the next 32 bits of data (beginning at offset +5) are to be interpreted as a “Scale Minimum Float” in the form of a floating point value. In the present example, the “Scale Minimum Float” is 0.

According to the AnalogInputModule definition 500 (see FIG. 5), the next 16 bits of data (beginning at offset +7) are to be interpreted as a “Scale Maximum Integer” in the form of an unsigned integer. In the present example, the “Scale Maximum Integer” is 32.

According to the AnalogInputModule definition 500 (see FIG. 5), the next 32 bits of data (beginning at offset +8) are to be interpreted as a “Scale Maximum Float” in the form of a floating point value. In the present example, the “Scale Maximum Float” is 32.

According to the AnalogInputModule definition 500 (see FIG. 5), the next 16 bits of data (beginning at offset +10) are to be interpreted as an “Output Event or Register address” in the form of an unsigned integer. In the present example, the “Output Event or Register address” is 2006.

According to the AnalogInputModule definition 500 (see FIG. 5), the next 16 bits of data (beginning at offset +11) are to be interpreted as an “Instrument failure Event or Register address” in the form of an unsigned integer. In the present example, the “Instrument failure Event or Register address” is 0.

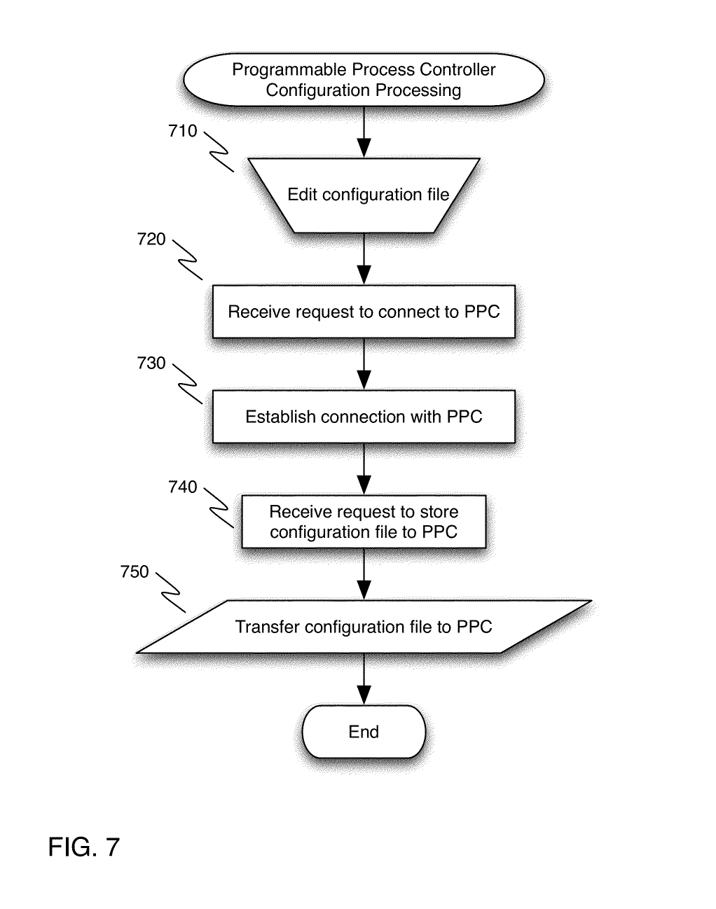

FIG. 7 is a flow diagram illustrating programmable process controller configuration processing in accordance with an embodiment of the present invention. Depending upon the particular implementation, the various process and decision blocks described below may be performed by hardware components, embodied in machine-executable instructions, which may be used to cause a general-purpose or special-purpose processor programmed with the instructions to perform the steps, or the steps may be performed by a combination of hardware, software, firmware and/or involvement of human participation/interaction.

At block 710, an end user of a configuration device manually edits a configuration file. The editing may be performed indirectly via a configuration file editing application or directly via a text editor (and without the use of a configuration utility). Notably, in one embodiment, the configuration file can be encrypted and secured for secure, defense, and/or Department of Homeland Security applications, for example.

At block 720, the configuration device receives a request to connect to a programmable process controller (PPC). In one embodiment, this request may be in the form of a user-initiated request for the configuration device to look for other discoverable Bluetooth capable devices in the area. In other embodiments, this request may be responsive to physically interfacing the configuration device with the PPC.

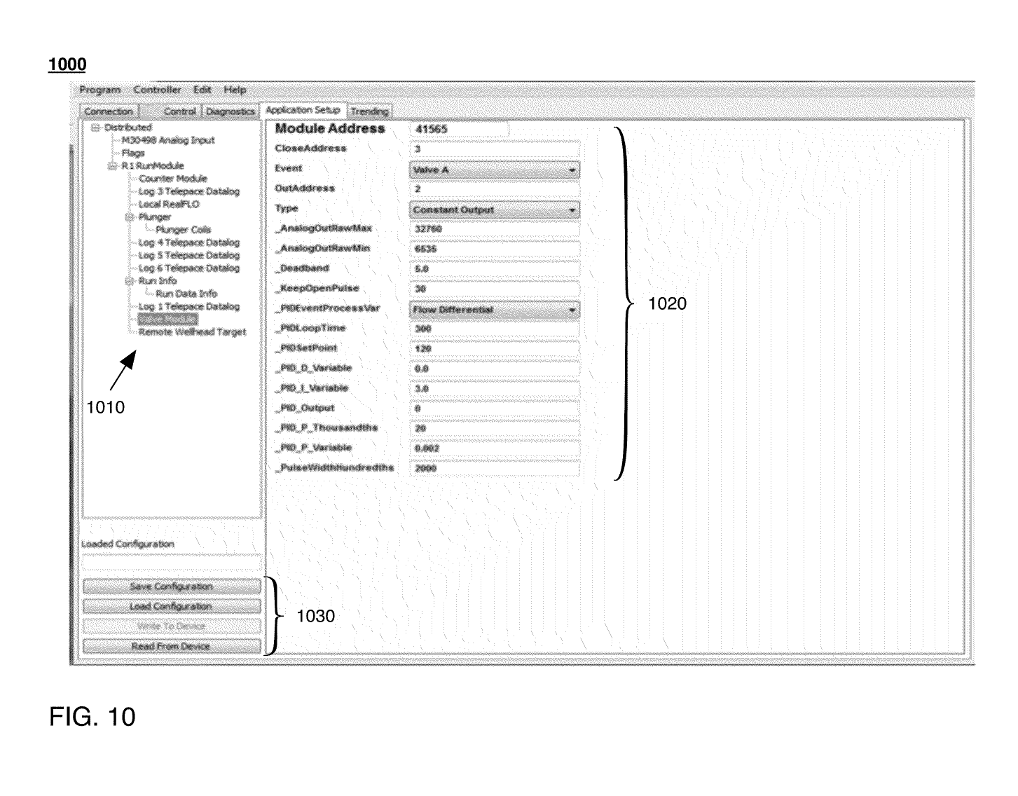

At block 730, a connection is established between the configuration device and the PPC. At block 740, the configuration device receives a request to write the locally stored configuration file to the PPC. In one embodiment, this is a user-initiated request from a configuration utility, such as that discussed below with reference to FIG. 10. In other embodiments, this request may indirectly result from an operating system or file system request responsive to user-initiated activity with respect to the configuration file (e.g., a request to move the configuration file to the PPC, a request to copy/cut from the configuration device and paste to the PPC or the like). The request may also be initiated by a technician from the PPC via a command line or other interface. Alternatively, the request may be initiated by a process control application running on the PPC.

At block 750, the configuration file is transferred to the PPC. In one embodiment, the configuration file is written (pushed) to a Modbus address space. In other embodiments, a process control application may read (pull) the configuration file during startup processing.

While the simplified example above, simply illustrates the ability for a configuration file to be written to a PPC. In alternative embodiments, as described further below, the configuration device may also permit a configuration file to be retrieved from the PPC, edited and then written back to the PPC.

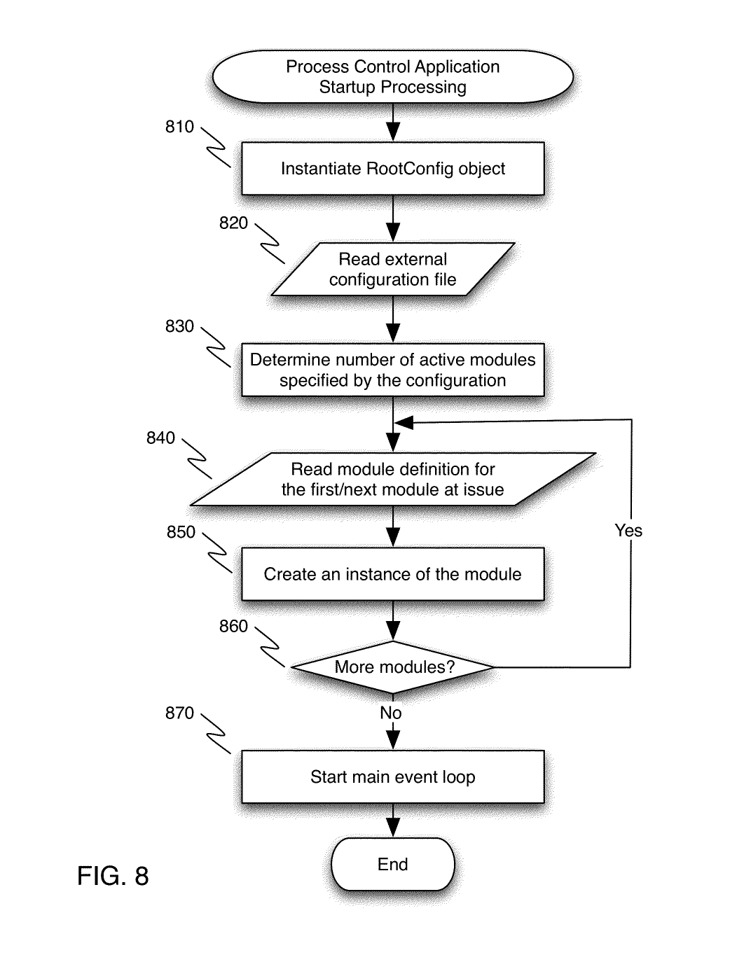

FIG. 8 is a flow diagram illustrating process control application startup processing in accordance with an embodiment of the present invention. Depending upon the particular implementation, the various process and decision blocks described below may be performed by hardware components, embodied in machine-executable instructions, which may be used to cause a general-purpose or special-purpose processor programmed with the instructions to perform the steps, or the steps may be performed by a combination of hardware, software, firmware and/or involvement of human participation/interaction. According to the present example, the process control application has already begun its startup processing by locating the base address of the root portion of an external configuration file by reading the base address from a hardcoded Modbus address, for example.

At block 810, the process control application instantiates a RootConfig object to process the root portion of an external configuration file. In one embodiment, the root portion contains information specifying the number, type and location of parameter values of modules that are to be instantiated.

At block 820, the RootConfig object begins reading the external configuration file.

At block 830, the RootConfig object parses the data retrieved from the external configuration file in accordance with a root configuration definition (e.g., RootConfig 400) to determine the number of active modules that are specified by the external configuration file.

At block 840, the RootConfig object enters a loop in which it reads module definitions for each of the active modules.

Once a complete set of parameter values have been read for the module at issue, at block 850, the RootConfig object creates an instance of the module configured in accordance with the parameter values.

At decision block 860, it is determined whether there are additional modules to be processed and instantiated. If additional modules remain to be processed, then process control application startup processing loops back to block 840; otherwise all desired modules have been instantiated and processing continues with block 870.

At block 870, all modules specified by the external configuration file have been instantiated, therefore the main event loop is started. After the main event loop has been started, process control application startup processing is complete.

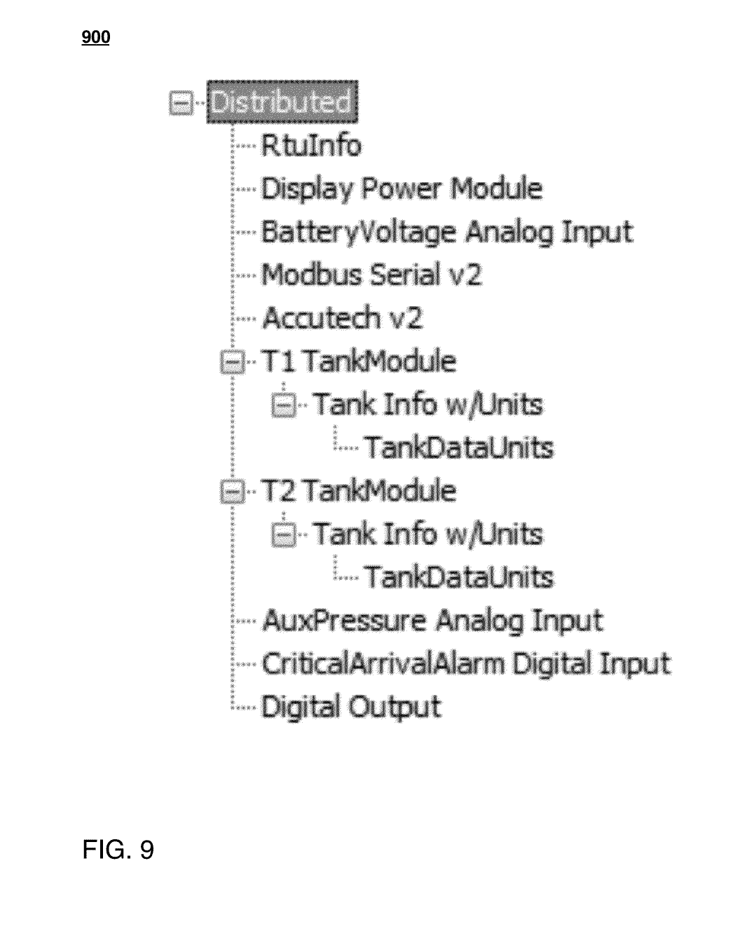

FIG. 9 is an example of a representation of a configuration tree 900 in accordance with an embodiment of the present invention. This hierarchical view of configuration tree 900 is shown simply to note that while some embodiments may represent configuration information in the form of a particular data structure which is to be interpreted in accordance with various module definitions, in alternative embodiments, the hierarchical nature of the modules and associated parameter values may naturally lend themselves to use of an XML representation.

FIG. 10 is a screen shot 1000 of a configuration file editing application in accordance with an embodiment of the present invention. According to this example, the configuration file editing application may allow a technician to add, delete and/or modify existing module definitions displayed in the context of a configuration tree 1010 by using familiar user interface mechanisms 1020, such as text entry fields, drop down lists and the like. Buttons 1030 may be used to: (i) save the current configuration to a file stored on the configuration device, for example; (ii) load a configuration from a file stored on the configuration device, for example; (iii) write the current configuration file to a connected PPC, for example; or (iv) read the currently employed configuration file from a connected PPC, for example.

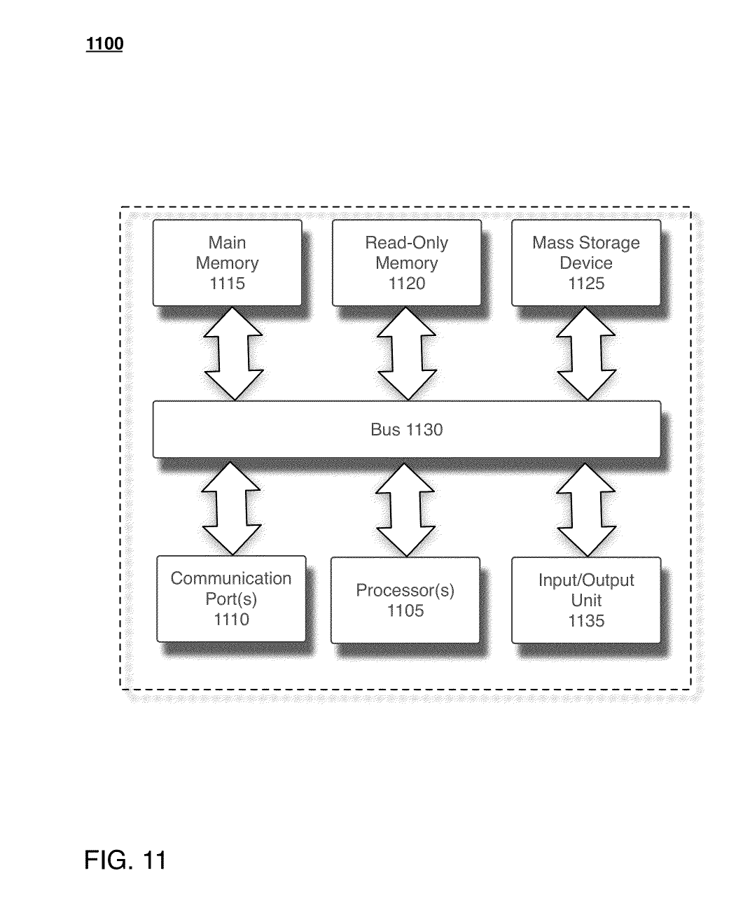

FIG. 11 is an example of a computer system with which embodiments of the present invention may be utilized. The computer system 1100 may represent or form a part of a PLC, RTU, wireless mobile device and/or workstation.

Embodiments of the present invention include various steps, which will be described in more detail below. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

According to FIG. 11, the computer system includes a bus 1130, one or more processors 1105, one or more communication ports 1110, a main memory 1115, an optional removable storage media (not shown), a read only memory 1120, an optional mass storage device 1125 and an optional input/output unit

In the context of a wireless mobile device and/or a workstation, processor(s) 1105 can be any future or existing processor, including, but not limited to, an Intel® Itanium® or Itanium 2 processor(s), or AMD® Opteron® or Athlon MP® processor(s), or Motorola® lines of processors. In the context of a programmable process controller (e.g., a PLC, an RTU or the like), processor(s) 1105 are typically hardened to withstand vibrations, temperature, humidity, noise and other adverse conditions that may be present in an industrial, manufacturing or other environments in which such controllers may be deployed. For example, in one embodiment, the processor(s) 1105 can be a current or future processor from the Control Microsystems or Schneider Electric SCADAPack family of controllers, MicroLogix, CompactLogix or ControlLogix families of processors (available from Allen Bradley, Inc.), the Siemens Simatic Micromaster PLC future or existing processor, including, but not limited to, an Intel® Itanium® or Itanium 2 processor(s), or AMD® Opteron® or Athlon MP® processor(s), or Motorola® lines of processors.

Communication port(s) 1110 can be any of an RS-232 port for use with a modem based dialup connection or a physical connection to another RS-232 enabled device, a 10/100 Ethernet port, a Gigabit port using copper or fiber, a short-range wireless communications chip/chipset (e.g., an integrated Bluetooth radio) or other existing or future ports. Communication port(s) 1110 may be chosen depending on a network, such a control network, Local Area Network (LAN), Wide Area Network (WAN), or any network to which the computer system 1100 connects.

Main memory 1115 can be Random Access Memory (RAM), or any other dynamic storage device(s) commonly known in the art. Read only memory 1120 can be any static storage device(s) such as Programmable Read Only Memory (PROM) chips for storing static information such as start-up or BIOS instructions for processor 1105.

In the context of a wireless mobile device and/or a workstation, the optional mass storage device 1125 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 1130 communicatively couples processor(s) 1105 with the other memory, storage and communication blocks. Bus 1130 can include a bus, such as a Peripheral Component Interconnect (PCI)/PCI Extended (PCI-X), Small Computer System Interface (SCSI), USB or the like, for connecting expansion cards, drives and other subsystems as well as other buses, such a front side bus (FSB), which connects the processor(s) 1105 to system memory. In the context of a chassis-based system, bus 1130 may represent a backplane through which both control and data signals are passed among modules of the chassis.

Optionally, local operator and administrative interfaces, such as a display, keyboard, touch screen and/or a cursor control device, may also be coupled to bus 1130 to support direct operator interaction with computer system 1100. Other operator and administrative interfaces (e.g., browser based or command line) can be provided through network connections connected through communication ports 1110.

Optional removable storage media (not shown) can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM).

In the context of a programmable process controller (e.g., a PLC, an RTU or the like), input/output unit 1135 allows the processor 1105 to receive information from external devices (e.g., field devices/instrumentation 111a-111n) and communicate information to such external devices. Depending on the usage context, The inputs might be from switches, or other sensors, such as photoelectric cells, temperature sensors, flow sensors, or the like. The outputs might be to motor starter coils, solenoid valves, or similar things. Components described above are meant only to exemplify various possibilities. In no way should the aforementioned exemplary computer system limit the scope of the invention.

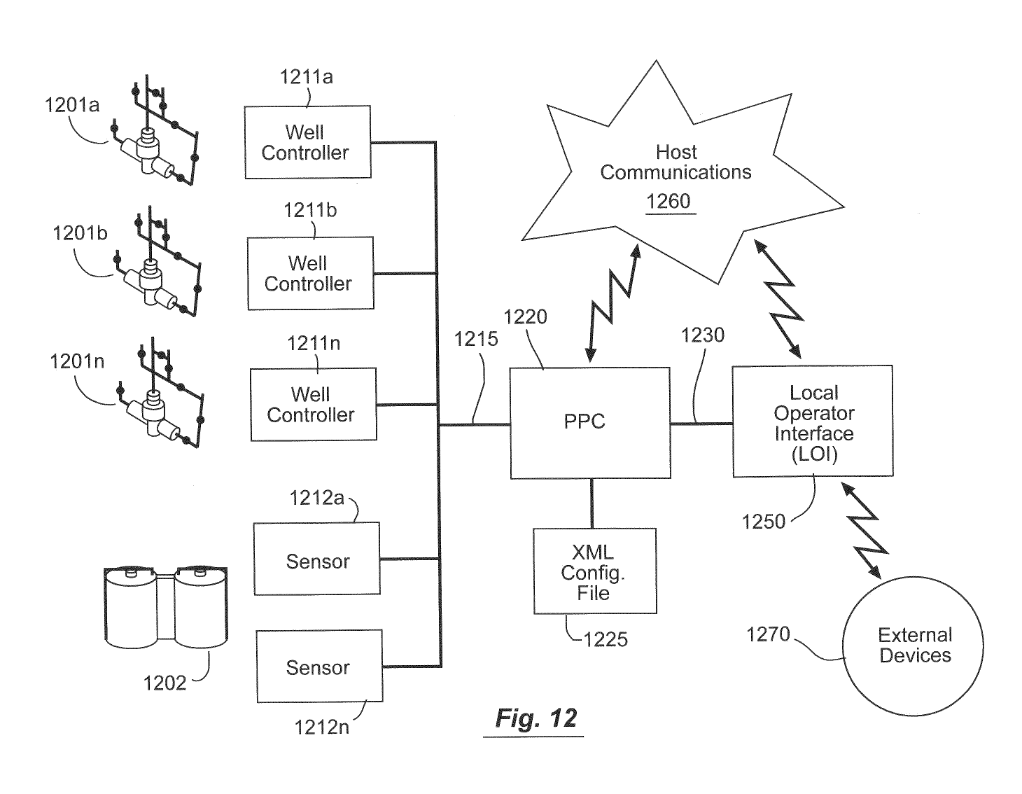

Dynamically-Configurable Local Operator Interface. Turning to FIGS. 12-25, another embodiment of the present invention is described that provides an improved local operator interface (LOI) for use primarily in combination with the configuration-based PLC programming system illustrated in FIGS. 1-11 and described above.

FIG. 12 is a block diagram of this embodiment using a local operator interface (LOI) 1250 to provide a graphical user interface based on the configuration data file 1225 stored by the programmable process controller (PPC) 1220. In this embodiment, an Android application, running on Android-based hardware with a touch screen display, functions as both an local operator interface and a configuration setup tool. For example, the LOI unit 1250 can be implemented as on single board computer (SBC) physically mounted in the same enclosure as the PPC 1220 and having a wired connection 1230 to the PPC 1220. The LOI unit 1250 will contain appropriate drivers to facilitate Android-to-PPC communications, such as but not limited to Modbus RTU and Modbus TCP.

On boot-up, the LOI 1250 reads the configuration data 1225 (e.g., an eXtensible Markup Language or XML file) from the PPC 1220 and dynamically creates appropriate graphical user interface (GUI) screens and/or selects appropriate interface screens from a preset library of predefined graphical user interface screens based on the configuration. This eliminates the need for LOI programming. For example, when one or more new measurement and control devices (e.g., well controllers 1211a-1211n, sensors 1212a-1212n associated with wells 1201a-1201n, tanks 1202, valves, etc.) are added to or removed from a well site, the LOI 1250 can be reconfigured by simply uploading a new configuration file 1225 with information regarding the current measurement and control devices.

The LOI unit 1250 may run as a local web server, thereby providing a browser-based interface to view, operate or configure the system via a physical connection (e.g., an Ethernet port) or via a wireless (e.g., Wi-Fi) connection to a wireless access point supported by the LOI 1250. As such, an operator can interact with the LOI 1250 and PPC 1220 with an external device 1270 (e.g., a smart phone, a laptop, a tablet computer or the like) running a web browser. The LOI 1250 can also be used as a remote interface via a wireless communication with a host communication center 1260. The web server running on the LOI unit 1250 hosts data pages related to operational data concerning the operation and status of the upstream oil and gas operation. Tabs for alarms, reports, application setup and data import and export can be provided via a simple intuitive interface.

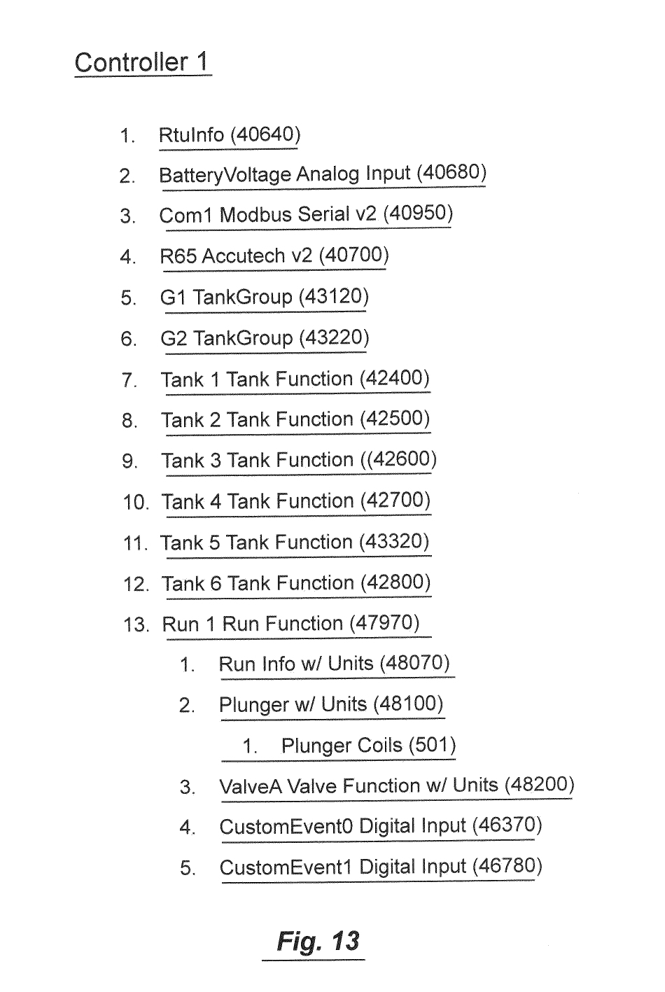

In one embodiment of the present invention, The LOI 1250 maintains a database holding the configuration data 1225 (e.g., in XML format) that is either automatically read, or read on demand from the PPC 1220, as shown for example in FIG. 13. Multiple PPCs are supported with the ability to read and store each separate controller on the data bus, as long as each controller has a unique network identifier, such as a Modbus RTU address.

The LOI 1250 also includes a configuration tool used to setup and edit the configuration data 1225 to reflect the configuration of the wellhead equipment. For example, this configuration data can be stored in XML format in the LOI's database. Revised configuration data can be written out by the LOI 1250 to the PPC 1220 to update and replace the existing configuration file 1225 stored by the PPC 1220 for its use. This feature provides a web-based interface for configuration, and eliminates the need for an external PC-based configuration program, together with all of the maintenance and version control issues associated with external PC applications. The configuration tool also supports imports and exports of configuration data in XML format.

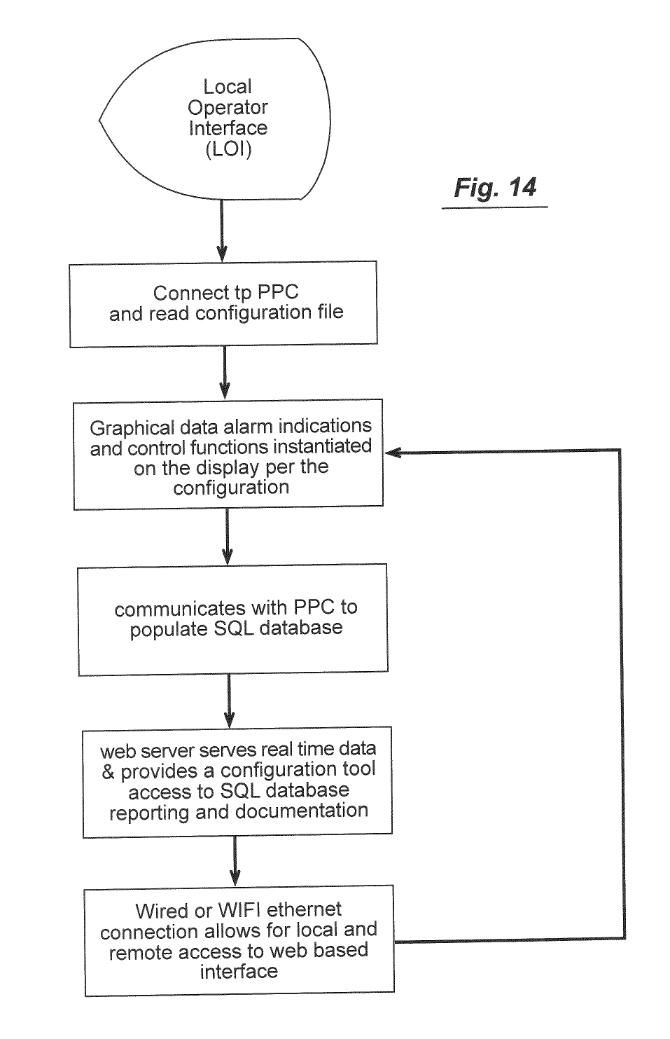

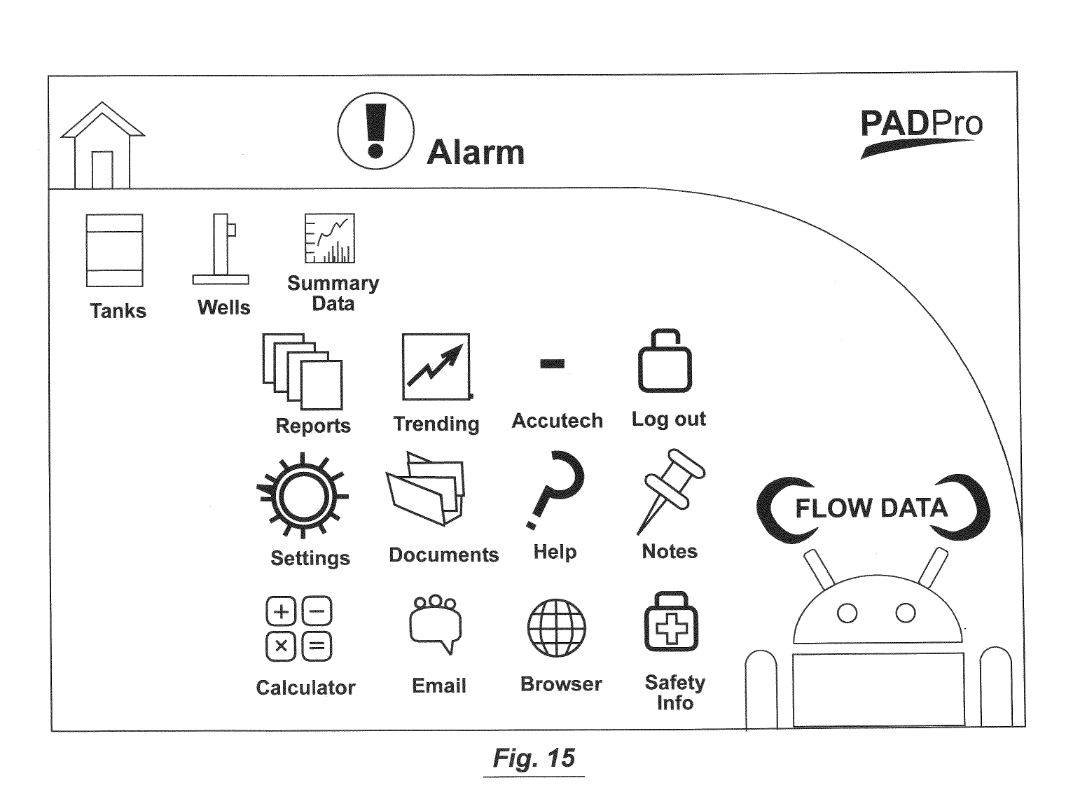

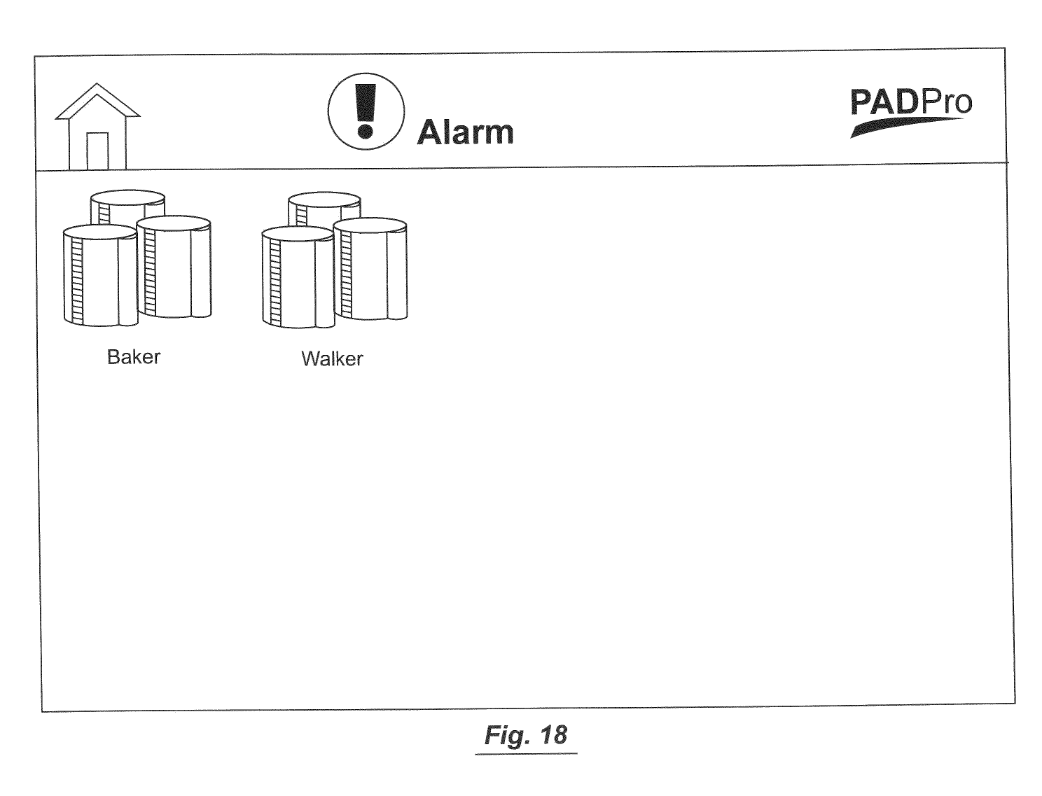

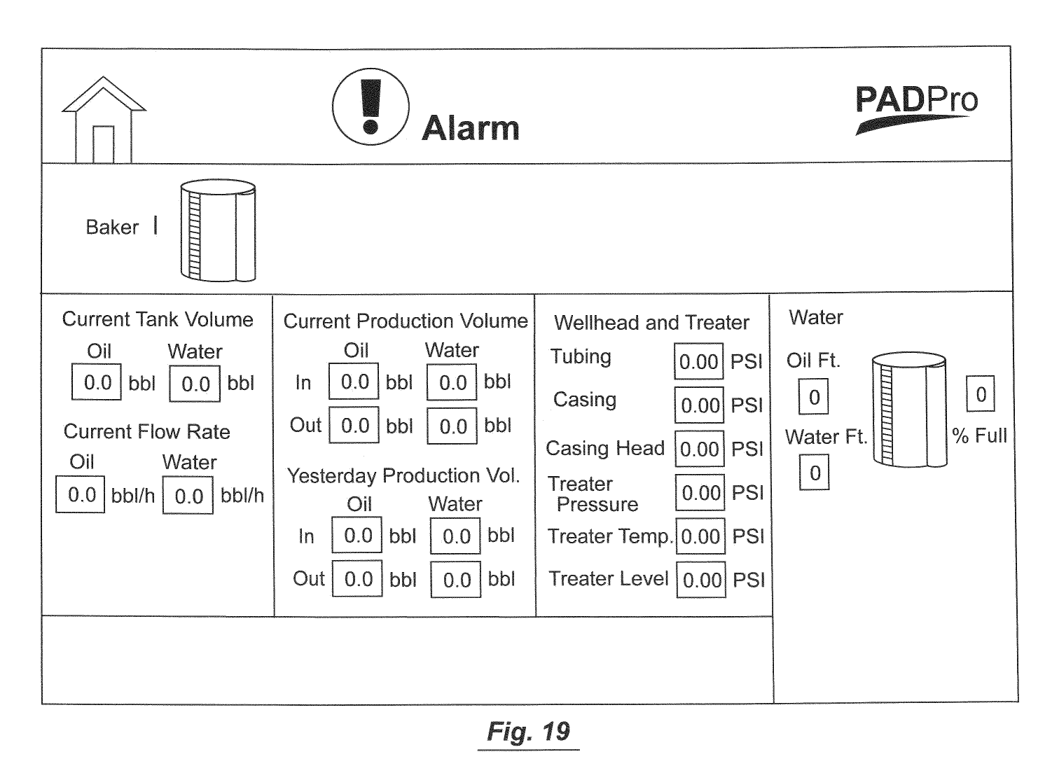

FIG. 14 is a simplified flowchart of the application run by the LOI 1250. To summarize, the LOI 1250 initially reads its configuration data from the PPC 1220 and builds a local configuration database. The LOI 1250 then renders its screen displays to provide a graphical user interface (GUI) matching that configuration of wellhead equipment. To be consistent with upstream oil and gas wellhead operations, the system typically segregates the icons in its GUI into groups of monitoring and control subsets, such as tanks, wells, summary data, pad items, and data trending. Each subset within the GUI will automatically appear if these components exist in the active configuration of wellhead equipment. For example, in a system that has a configuration that contains no tank components, the “Tank” subset icon will not appear. On the other hand, a configuration that contains four tanks will automatically include a “Tank” subset icon on the screen, as shown for example in FIG. 15. Also, subsidiary screens will include four tank icons, with identifiers for each individual tank. FIG. 18 is an example of a subsidiary screen showing two tanks identified as “Baker” and “Walker.” FIG. 19 is an example of a further subsidiary screen for the “Baker” tank.

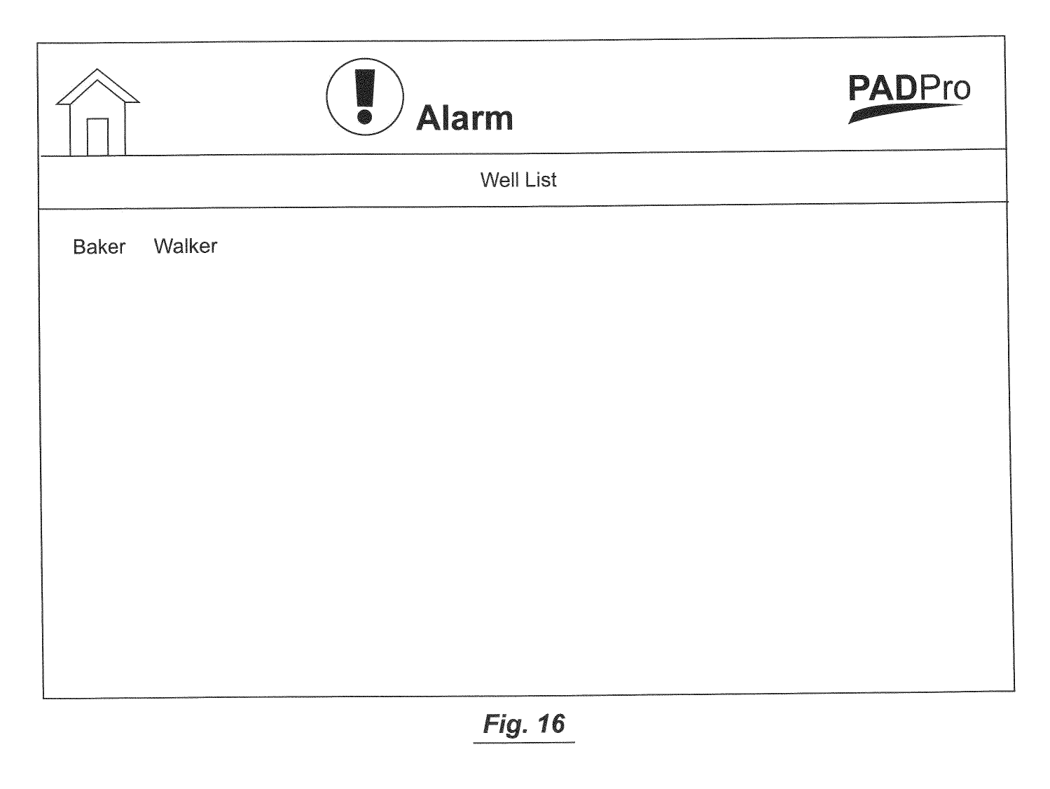

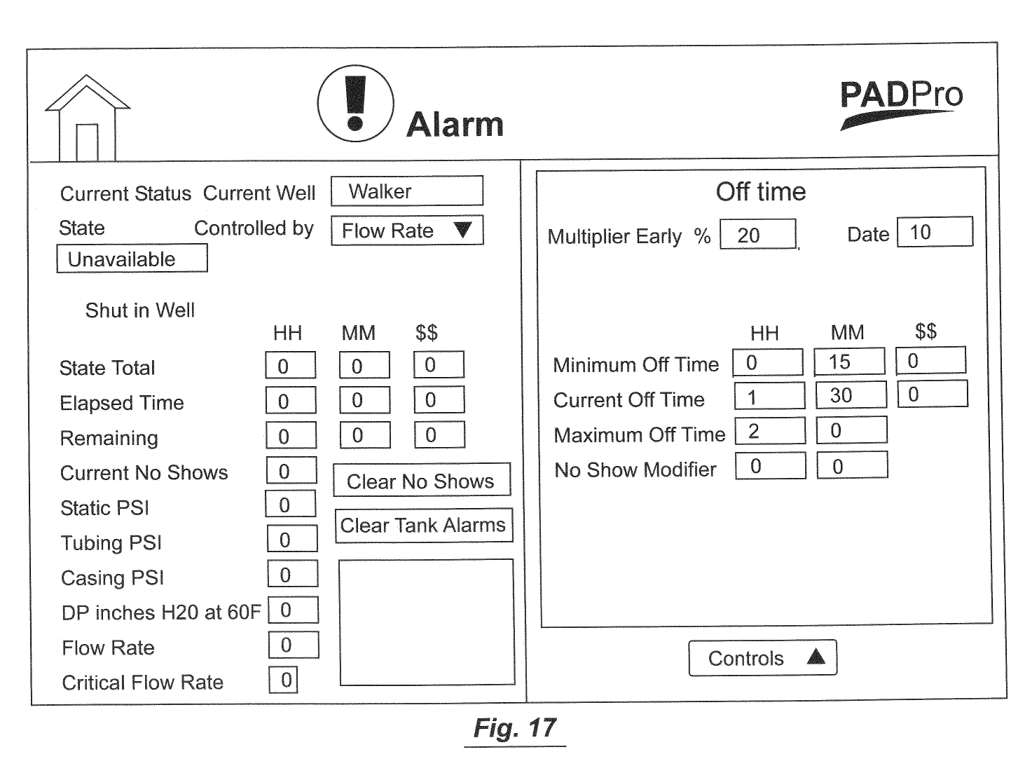

The same convention is carried out for the number of wells in a configuration. In other words, the LOI 1250 will render an instance of the “Well” subset icon, as shown in FIG. 15, if at least one well is present in the configuration, and also render icons for each well in subsidiary screens. FIG. 16 is an example of a subsidiary screen showing two wells identified as “Baker” and “Walker.” FIG. 17 is an example of a further subsidiary screen for the “Walker” well.

Following this convention, the LOI 1250 can also customize the GUI to include data tags, monitoring point, alarms and trends for each item as they exist in the configuration tree. The result is a system that dynamically renders a GUI for the operator to match the configuration of the PPC and its wellhead equipment without the need for specialized LOI programming.

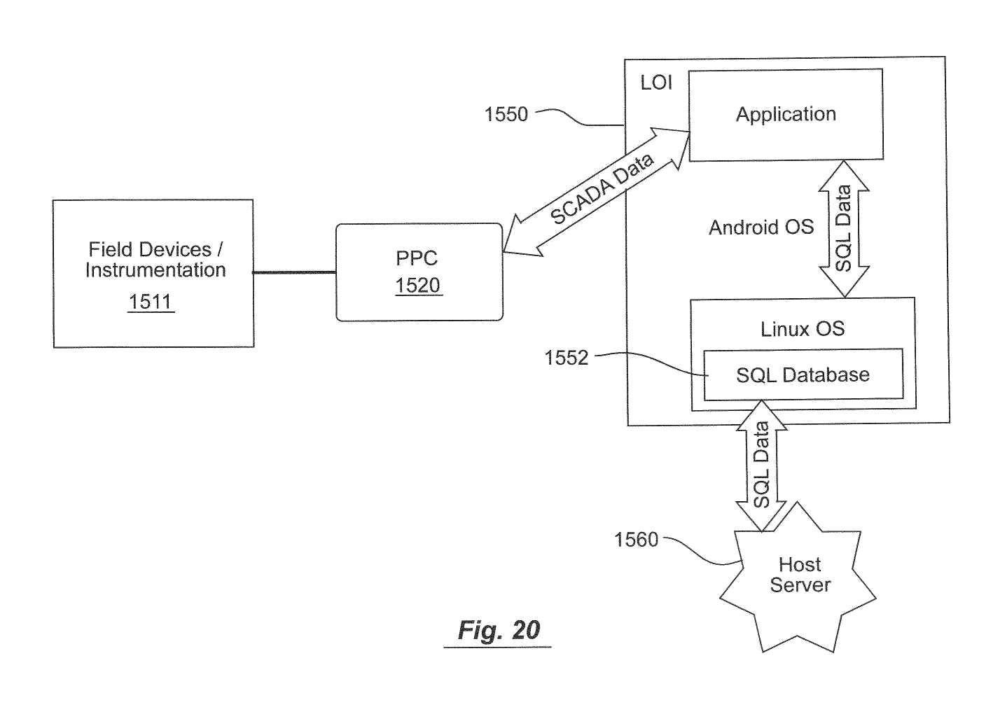

According to one embodiment, the LOI includes local database management software (e.g., SQL) that facilitates, among other things, local viewing of customizable reports and historical trending. FIG. 20 is a block diagram of an embodiment of the present invention using a LOI 1550 equipped with a SQL database 1552. This database software allows the LOI 1550 to store historical data for local or remote trending and reporting of data gathered by the PPC 1520 from field devices and instrumentation 1511 that is reported to the LOI 1550. The database software 1552 also allows transaction-based solutions, such as truck ticketing. SQL data can also be exported to external devices or a remote host server 1560.

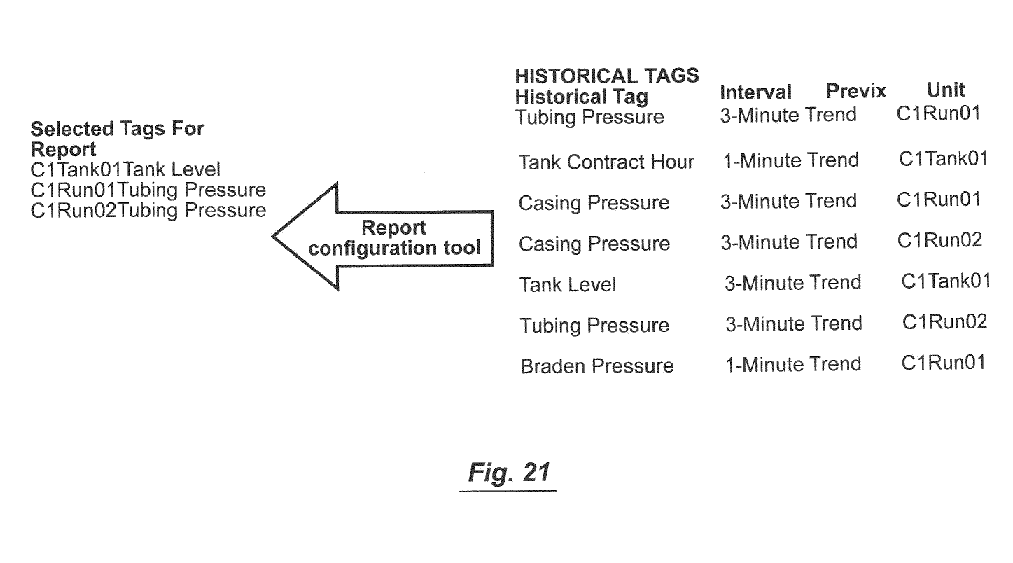

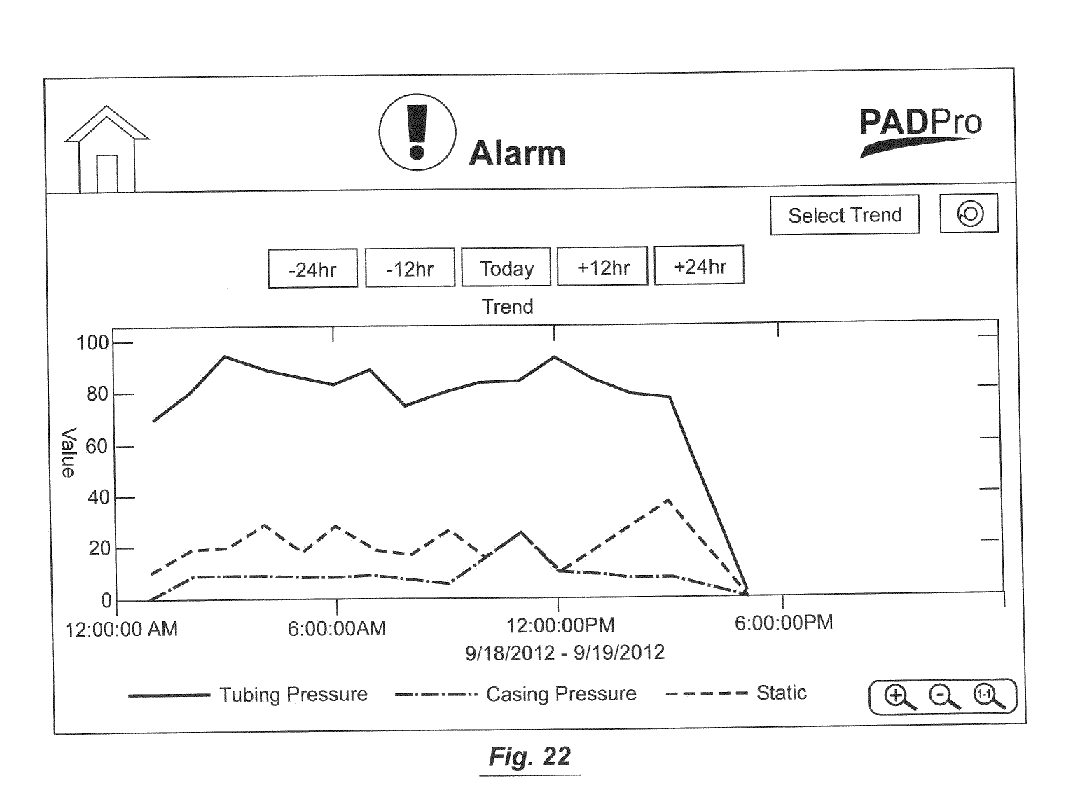

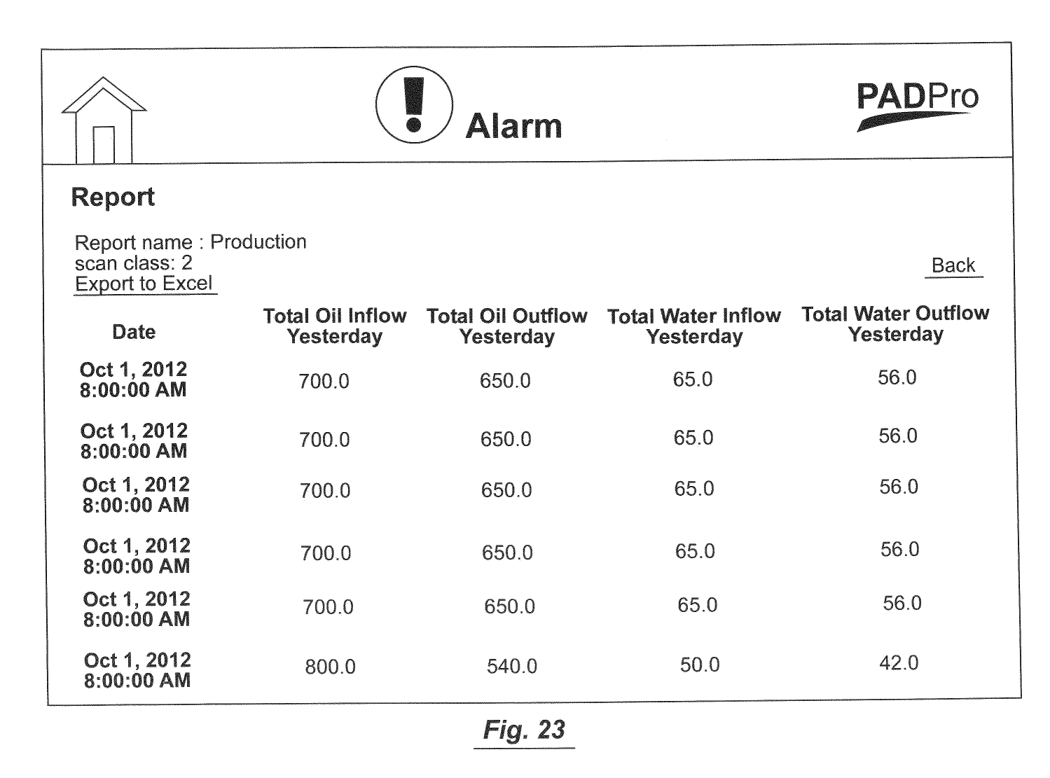

The LOI may include a report configuration tool allowing the operator to configure customized reports built from data collected by the local SQL database, as depicted in FIG. 21. The report data points are organized by scan classes, but the operator can select which data points the reports contain, as illustrated for example in FIG. 21. FIG. 22 is an example of a customized graphic report that can be generated using the SQL database. FIG. 23 is an example of a customized tabular report. The reports can be viewed using the web page interface either locally or remotely. In addition, the report data can be exported using the web interface, thereby eliminating the need for an external report server.

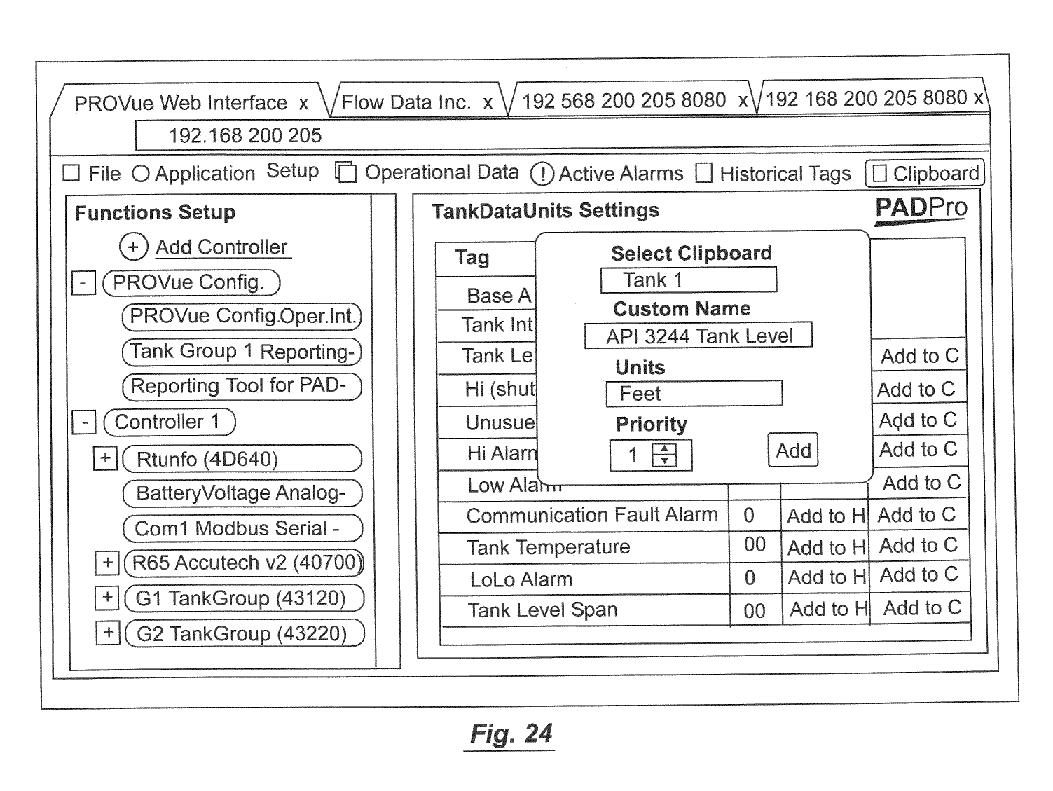

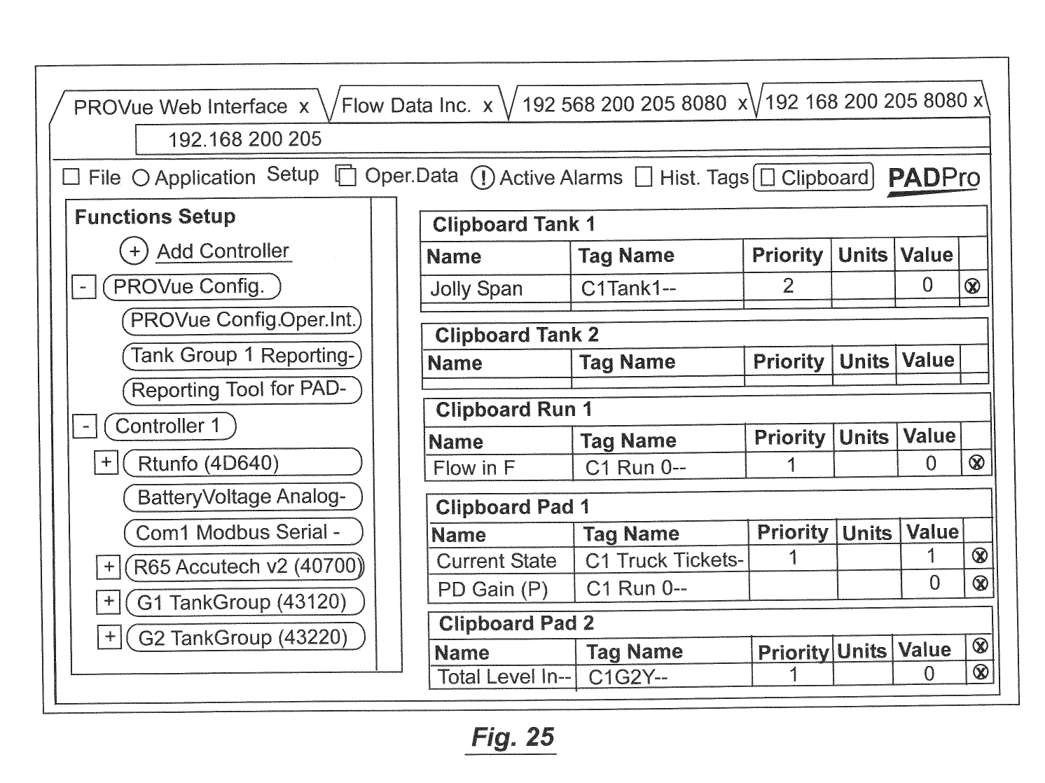

Many data tags exist in typical oil and gas wellhead operator interfaces. But, it is usually not practical or necessary to display every data tag. The present LOI provides a clipboard configuration tool for the user to select any data tag in the system and display it on the LOI. The interface used to create clipboard screens includes a mechanism to rename the data tag to an alternative name designated by the user. This allows the user to customize the screen data without programming. FIG. 24 is an example of clipboard tag selection in which the user selects a tag in the configuration, renames it, and places it in the clipboard. Many pages of clipboards can be supported. FIG. 25 is an example of a clipboard configuration.

The LOI may also include local document storage in which user manuals for the LOI applications and the hardware can be stored and accessed via the local web server. The local document storage may also contain electrical panel drawings and schematics that can be viewed via the interface screens. The local document storage may also facilitate presentation of instructional web pages, videos and wiki-based help to the operator. These documents can be viewed or uploaded to other external devices via Wi-Fi or Bluetooth communications.

Furthermore, while some examples are given with reference to PLCs, the dynamic reconfiguration techniques described herein are equally applicable to other types of programmable process controllers and other devices in which or with which such programmable processors might be integrated, such as multivariable transmitters (MVTs), pad controllers, well controllers, RTUs and the like.

Finally, those skilled in the art will recognize various other alternative configuration mechanisms, including: (i) reading of an externally stored text file, comma-separated value (CSV) file or XML file; (ii) reading of a text file, CSV file or XML file stored within a memory of a programmable process controller; or (iii) reading configuration information from a remote location at start or re-start.

Embodiments of the present invention include various steps that may be performed by hardware components or may be embodied in machine-executable instructions, which may be used to cause a general-purpose or special-purpose processor programmed with the instructions to perform the steps. Alternatively, the steps may be performed by a combination of hardware, software, firmware or by human operators.

Embodiments of the present invention may be provided as a computer program product, which may include a non-transitory machine-readable storage medium tangibly embodying thereon instructions, which may be used to program a computer (or other electronic devices) to perform a process. The non-transitory machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, volatile or nonvolatile (e.g., battery backed up Complementary Metal Oxide Semiconductor (CMOS)) random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

### Terminology

The term “client” generally refers to an application, program, process or device in a client/server relationship that requests information or services from another program, process or device (a server) on a network. Importantly, the terms “client” and “server” are relative since an application may be a client to one application but a server to another. The term “client” also encompasses software that makes the connection between a requesting application, program, process or device to a server possible, such as but not limited to an FTP client, a Modbus slave client, or an OPC (ODBC for Process Control) server client.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phrases do not necessarily refer to the same embodiment.

The phrase “local operator interface” and the acronym “LOI” generally refer to a human machine interface for a programmable process controller through which an operator may provide commands and input to the programmable process controller and receive output or feedback from the programmable process controller. As discussed above, LOIs for oil or gas well controllers have customarily been in the form of a scrolling one or two-line text-based display and a set of hardware function keys. In embodiments of the present invention, an improved LOI may take the form of a fully functional digital computer, such as Android-based hardware running Linux with an interactive touch-screen display. As described further below, in various embodiments, the interface screens presented to the operator by the LOI can be dynamically configured (e.g., selected from a preset library of possible interface screens) based on configuration information contained within a configuration file. The configuration file may be stored within the programmable process controller, which may use the same or a different configuration file to configure the structure, functionality and/or type and number of objects/modules of a process control program to be executed by the programmable process controller. In this manner, one or both of the programmable process controller and the LOI can be dynamically reconfigured without performing reprogramming by simply uploading a new configuration file to the programmable process controller.

If the specification states a component or feature “may”, “can”, “could”, or “might” be included or have a characteristic, that particular component or feature is not required to be included or have the characteristic.

The phrase “process control management system” generally refers to a system including a programmable process controller and a corresponding LOI. In one embodiment, the programmable process controller and the LOI are enclosed within a common housing; however, the programmable process controller and the corresponding LOI may be physically separated to accommodate a particular implementation and/or usage environment.

The phrase “programmable process controller” or “PPC” generally refers to a digital computer that is optimized for control tasks (e.g., integrated input/output (I/O) for sampling/monitoring signals from external devices, including, but not limited to measurement and control devices, and providing command signals to the external devices) and/or an industrial environment (e.g., designed to withstand vibrations, temperature, humidity and noise and comply with specific electromagnetic interference (EMI), radio-frequency interference (RFI) and/or electromagnetic compatibility (EMC) requirements). A remote terminal unit (RTU) and a programmable logic controller (PLC) are two examples of programmable process controllers (PPCs). Programmable process controllers are typically capable of running a compiled program. In co-pending and commonly-owned U.S. patent application Ser. No. 13/038,368 entitled “Configuration Based Programmable Logic Controller (PLC) Programming,” the disclosure of which is incorporated by reference herein, systems and methods are described for dynamically reconfiguring the structure of the program (e.g., a process control application being run by the PLC), the functionality of the program, the type and number of objects/modules instantiated by the program and the like without changing and/or recompiling the program by using a configuration file. As described further below, in embodiments of the present invention, the same or a different configuration file is proposed to be used herein to facilitate dynamic configuration of interface screens to be presented on a touch-screen display of an LOI while avoiding the traditionally required process of reprogramming of the LOI.

The term “responsive” includes completely or partially responsive.

The term “server” generally refers to an application, program, process or device in a client/server relationship that responds to requests for information or services by another program, process or device (a server) on a network. The term “server” also encompasses software that makes the act of serving information or providing services possible.

The term “graphical user interface” or “GUI” generally includes any type of processor-driven interface or display presenting an operator with control options or information in graphical format (e.g., icons), and allowing the operator to dynamically interact with the display by means of a touch screen, touch pad, mouse, joystick, or similar input devices.

The term “database management software” generally includes computer software for inputting, storing, retrieving, and managing large quantities of data, including hierarchical, relational databases (such as SQL and Microsoft Access) and non-relational databases.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

We claim:

1. A method for providing a local operator interface to a programmable process controller (PPC) for wellhead equipment comprising:
storing configuration data on the PPC reflecting the configuration of the wellhead equipment, said configuration data being used by the PPC in controlling operation of the wellhead equipment;
providing a local operator interface unit in communication with the PPC having a display;
retrieving the configuration data from the PPC to the local operator interface unit;
generating a graphical user interface on the display of the local operator interface unit based on the configuration data to accept operator inputs; and
selectively controlling operation of the PPC by operator inputs via the graphical user interface of the local operator interface unit.

2. The method of claim 1 wherein the configuration data is stored in XML (eXtensible Markup Language) format.

3. The method of claim 1 wherein the local operator interface unit further comprises database management software for retrieving, storing and reporting data from the PPC.

4. The method of claim 1 wherein the local operator interface unit further provides a wireless communications link with external devices.

5. The method of claim 1 wherein the graphical user interface comprises icons providing a graphic representations of the wellhead equipment based on the configuration data.

6. The method of claim 1 wherein the local operator interface unit further enables editing of the configuration data to reflect changes in the wellhead equipment, and stores the revised configuration data to the PPC to replace the previous configuration data.

7. A system for providing a local operator interface for wellhead equipment, said system comprising:
a programmable process controller (PPC) controlling wellhead equipment, and storing configuration data reflecting the configuration of the wellhead equipment; and
a local operator interface unit in communication with the PPC and having a processor and a display; said local operator interface unit retrieving the configuration data from the PPC, generating a graphical user interface on the display based on the configuration data, and selectively controlling operation of the PPC by operator inputs via the graphical user interface of the local operator interface unit.

8. The system of claim 7 wherein the configuration data is stored in XML (eXtensible Markup Language) format.

9. The system of claim 7 wherein the local operator interface unit further comprises database management software for retrieving, storing and reporting data from the PPC.

10. The system of claim 7 wherein the local operator interface unit further provides a wireless communications link with external devices.

11. The system of claim 7 wherein the graphical user interface comprises icons providing a graphic representations of the wellhead equipment based on the configuration data.

12. The system of claim 7 wherein the local operator interface unit further enables editing of the configuration data to reflect changes in the wellhead equipment, and stores the revised configuration data to the PPC to replace the previous configuration data.
